(19) United States
(12) Patent Application Publication
(10) Pub. No.: US 2013/0221110 A1
(43) Pub. Date: Aug. 29, 2013

(54) WIRELESS IC TAG

(71) Applicant: MITOMO CORPORATION, (US)

(72) Inventor: Kikuo KAGA, Tokyo (JP)

(73) Assignee: MITOMO CORPORATION, Kanagawa (JP)

(21) Appl. No.: 13/705,455

(22) Filed: Dec. 5, 2012

(30) Foreign Application Priority Data
Feb. 27, 2012 (JP) 2012-40776

(51) Int. Cl. G06K 19/077

(52) U.S. Cl. CPC G06K 19/07792
USPC 235/492

(57) ABSTRACT

A wireless IC tag, to which data can be written by an IC tag introducing machine, said wireless IC tag can ensure the communication distance required for writing and reading data in the wireless IC tag formed in a dimension that does not intensively affect the material for building a construction and is provided with antennas with performance of excellent directionality, is provided.

The wireless IC tag 1 according to the present invention is characterized in that an RFID tag module 3 is mounted on the columnar ferrite core 2 and the antennas 41 to 43 configured to be connected to said RFID tag module 3 are wound around the surface of said columnar ferrite core 2.

### BACKGROUND OF THE INVENTION

1. Field of the Invention

The present invention relates to a wireless IC tag adapted to perform reading and writing various product data, and particularly to a wireless IC tag comprising an RFID tag, both directionality and communication distance of which have been improved.

2. Prior Art

A method for implementing quality management for a product, which normally exists in any state of liquid, viscous or semi-solid during the manufacturing, such as fresh concrete and a thermoplastic resin, by incorporating an IC tag having been written with various data in advance in the product before said product has been hardened, and then reading said data or writing new data by means of the IC tag incorporated in the hardened product via radio communication, has already been known.

The wireless IC tag as described above is prepared by molding the tag substrate, to which a capacitor, an RFID tag module, an antenna coil and so on are mounted, with a resin material to shape the molded tag substrate into a small piece, the form of which is global, cylindrical, columnar or the like. The prepared wireless IC tag is then introduced into the material for building a construction before said material is hardened by means of an IC tag incorporating machine. Note that said tag substrate must be enclosed in the central portion of the molded resin piece and is caused to face a predetermined direction in order to effectively perform writing and reading operations of signals via radio communication. Besides, an IC tag provided with plural small recesses and/or grooves on its outer shell body formed of a resin material for aiming at enhancing the contact of the IC tag to the material for building a construction without causing gaps therebetween while keeping appropriate adhesiveness to each other, when the IC tag is introduced into the material for building a construction, and blended and mixed with fresh concrete, is also known.

### REFERENCES OF THE PRIOR ART

### Patent Documents

### [Patent Document 1]: Japanese Unexamined Patent Application Publication No. 2006-145385

### [Patent Document 2]: Japanese Unexamined Patent Application Publication No. 2009-282688

### [Patent Document 3]: Japanese Unexamined Patent Application Publication No. 1996-167015

### [Patent Document 4]: Japanese Unexamined Patent Application Publication No. 2005-64468

### SUMMARY OF THE INVENTION

The wireless IC tag of the type as described above is introduced into a material for building a construction, such as cement and mortar, together with gravel, water, etc. by means of an IC tag incorporating machine. The cement or mortar product incorporated with the wireless IC tags is fed by virtue of compressed air to a construction site and casted there to build a concrete construction, such as a building, a bridge and a tunnel. Consequently, the wireless IC tags are embedded in the concrete construction so that they locate at positions certain distance inside from the wall of the construction and are caused to face various directions at random.

At the time of unloading and casting of said cement or mortar product, and after hardening thereof, writing of data signals is started via radio communication. However, there is a problem of difficulty in implementing the effective communication when the radio communication is carried out in such a condition that the wireless IC tags are embedded at locations in the construction, which are so far from the wall surface, or when the radio communication is carried out in such a situation that the direction of the antenna to the reader/writer is turned away.

The suitable shape of the wireless IC tag to be introduced into the material for building a construction is columnar, bale-like or elliptic in view of the dispersibility, etc. However, when the conventional chip-shaped or plate-shaped IC tags (main body) are molded with a protective enclosure having the shapes as described above, the enclosed wireless IC tag may be unwillingly biased or inclined in the protective enclosure. This means such problems that the wireless IC tag to be enclosed may be in an exposed state from the protective enclosure to the outside, or that the antenna does not take a position suitable for carrying out radio communication could be caused.

It is an object of the present invention to provide a wireless IC tag, to/from which data writing and reading can be securely implemented by using an IC tag introducing apparatus, said wireless IC tag can be formed in a dimension which does not affect the strength of the material for building a construction to be incorporated with the wireless IC tag, can ensure a communication distance required for reading and writing data and is provided with an antenna having excellent directionality.

It is a further object of the present invention to provide a wireless IC tag which has such a strength and stability to chemicals that the wireless IC tag main body will not be affected even it is introduced into a material for building a construction to be incorporated with the wireless IC tag, such as a cement product and a mortar product. Further, it is also an object of the present invention to provide a wireless IC tag which is compatibly mingled with the material for building a construction to be incorporated with said wireless IC tag.

Therefore, the wireless IC tag according to the present invention is characterized in that an RFID tag module is mounted on a columnar ferrite core and antennas having been connected to said RFID tag module are wound around the surface of said columnar ferrite core.

The antennas being wound around the ferrite core are characterized by being composed of a primary antenna to be wound at substantially central part of the columnar ferrite core and a pair of secondary antennas to be wound at both lateral positions of said primary antenna.

The antenna to be wound around the ferrite core is characterized by being formed by printing technique.

Therefore, the wireless IC tag according to this invention is characterized in that it is prepared by molding a wireless IC tag main body comprising a ferrite core mounted with an RFID tag module and antennas with a protective enclosure.

The protective enclosure is characterized by being a columnar outer shell body.

The wireless IC tag according to this invention is further characterized in that circumferential protrusions are formed on both outer end peripheries of said columnar outer shell body.

Further, the wireless IC tag according to this invention is yet characterized in that a plurality of concave grooves extending to the axial direction are formed on the body section of the columnar outer shell body.

### BRIEF DESCRIPTION OF THE DRAWINGS

FIG. 1 is a perspective view of a wireless IC tag according to an example of the present invention.

FIG. 2 is a schematic circuit diagram of the wireless IC tag shown in FIG. 1.

FIG. 3 is a perspective view showing the state of the wireless IC tag shown in FIG. 1 when it is molded with a protective enclosure.

FIG. 4 is a front view showing the other type of the protective enclosure.

FIG. 5 is a perspective view showing the whole exterior appearance of a wireless IC tag introducing machine of the vertical type.

### DESCRIPTION OF THE REFERENCE NUMERALS

1 Wireless IC tag
2 Ferrite core
22 Ferrite core end surface
3 RFID tag module
31 Capacitor
32 Part of RFID tag module
41 Primary antenna
42, 43 Secondary antenna
5 Wireless IC tag
50 Outer shell body
51 Concave groove
52 Outer shell body end surface
6 Wireless IC tag
60 Outer shell body
61 Protrusion
62 Protrusion
63, 65 Burr-like protrusion
64 Concave groove
90 IC tag introducing machine
91 Tag releasing outlet
92 Feed hopper
93 Vibratory alignment device
94 Inclined falling chute
95 Vertical falling passage

### DETAILED DESCRIPTION OF THE PREFERRED EMBODIMENTS

Now, the examples according to the present invention are described with referring to the appended drawings. Note that the examples of the wireless IC tag to be introduced into fresh concrete during mixing thereof are given in the following, the wireless IC tag according to the present invention is not limited to the one to be incorporated with fresh concrete and may also be applied to a liquid, viscous or semi-solid materials, e.g. mortar, a thermoplastic resin material in the melted state, and gypsum before being hardened.

### EXAMPLE 1

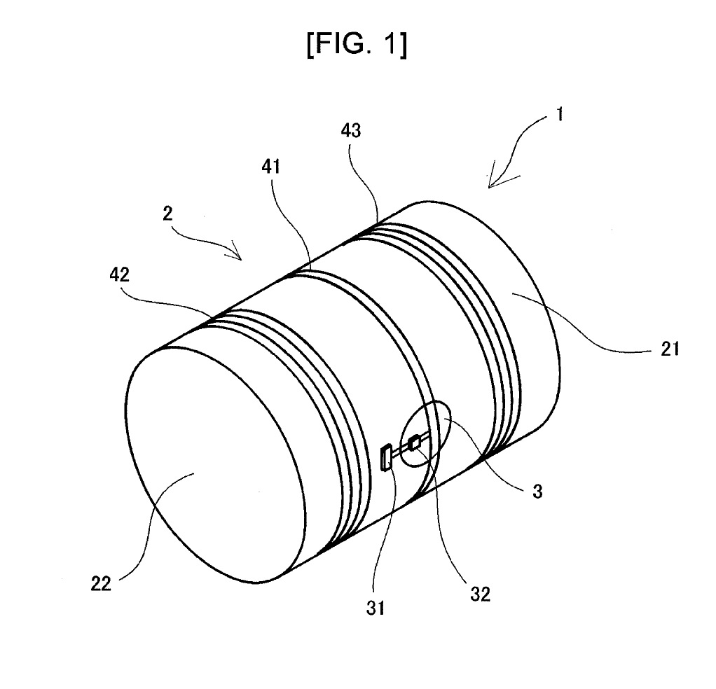

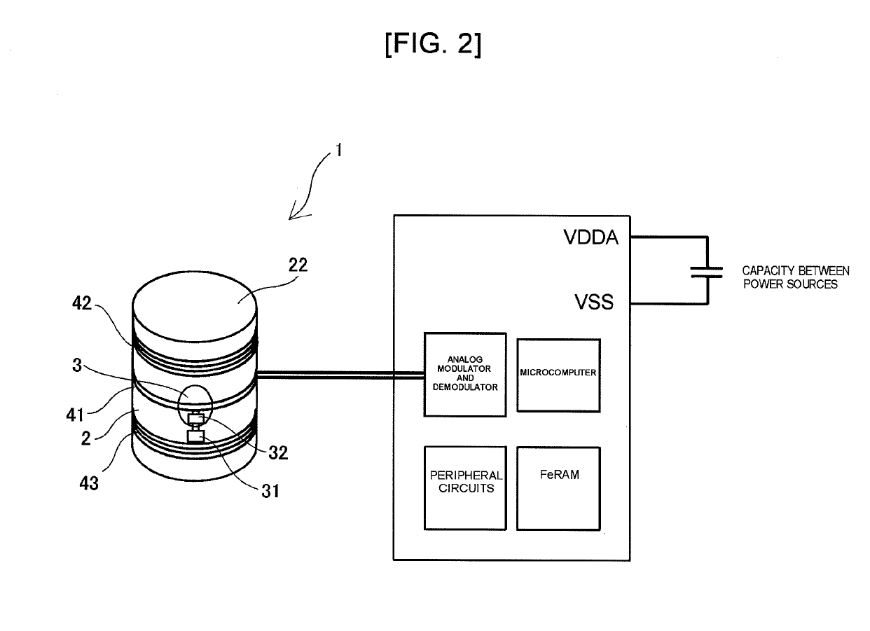

Now, the wireless IC tag 1 according to the first embodiment of the present invention is explained with referring to FIGS. 1 and 2. The wireless IC tag is constructed from a columnar ferrite core 2, an RFID tag module 3 adapted to be mounted to said ferrite core 2 and antennas 41 to 43 to be wound around the ferrite core 2.

The ferrite core 2 is a columnar ferrite core and is formed in this example in a dimension which can be enclosed inside the protective enclosure, that is, approximately 17 mm in the diameter (φ) and approximately 20 mm in the height.

An RFID tag module 3 is mounted on the surface of the ferrite core 2. The RFID tag module to be mounted on the ferrite core 2 is an RFID tag using an FeRAM (8 KByte) as a non-volatile memory utilizing a ferroelectric and is a chip in which an RFID tag module 3 including an FeRAM, an analog demodulator, a microcomputer, peripheral circuits, etc. are packaged and mounted on a substrate. To the RFID tag module 3, a capacitor 31 and a primary antenna 31 as well are connected. A capacity between power sources (30 μF in this example) is additionally provided to the RFID tag module 3 in order to take a measure against a limiting factor to the communication rate.

In this example, a two-stage booster ferrite core antenna is used in order to improve the directionality of an antenna to be used. A primary antenna 41 connected to the RFID tag module 3 is wound around the central position of the body section 21 of the columnar ferrite core 2, and secondary antennas 42, 43 are wound around the both lateral positions of said primary antenna 41. In this example, the primary antenna 41 is wound twice, and the secondary antennas 42, 43 are wound four times, respectively. These antennas 41 to 43 are formed on the ferrite core 2 by means of printing wiring technique. Then, data communication is implemented from the end surface 22 side in the axial direction of the antennas 41 to 43. In this example, communication is set up so that communication is carried out between the IC tag introducing machine 90 and the reader/writer (not shown) at the frequency band of 13.56 MHz.

By structuring the wireless IC tag 1 as described above, a wireless IC tag, which can be operated with low magnetic field, has excellent antenna directionality and can perform excellent communication in terms of communication distance and the rate, can be provided. Note that, although the shape of the ferrite core 2 is formed in columnar, it should be noted that the ferrite core may be formed in a flat shape so as to suit it to the shapes of the protective enclosure and the IC tag introducing machine to be used.

### EXAMPLE 2

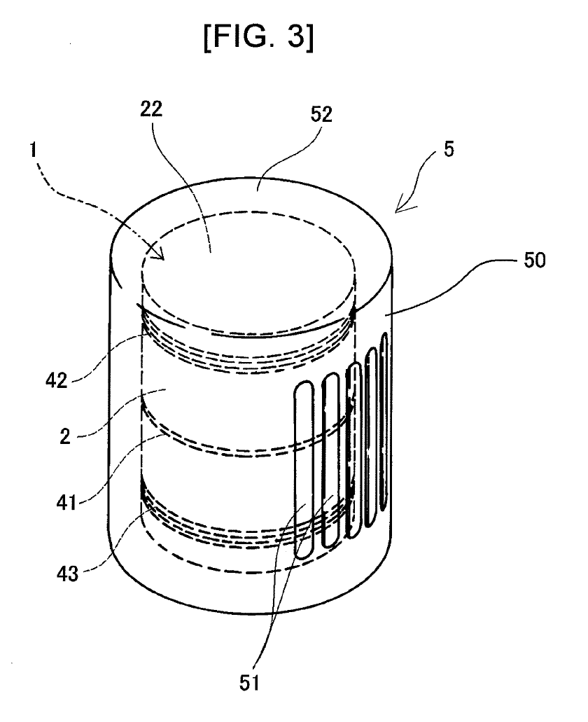

The wireless IC tag 5 shown in FIG. 3 is formed by covering the wireless IC tag (main body) 1 shown in FIG. 1 with a protective enclosure. The protective enclosure is a outer shell body 50 generally shaped in a columnar form with the diameter (φ) of c.a. 17 mm and the height of c.a. 20 mm. And, in the body section of the columnar outer shell body 50, a plurality of shallow concave grooves 51 extending in the axial direction are formed. In the interior of the columnar outer shell body 51, the end surface 22 in the axial direction of the wireless IC tag (main body) 1 comprising the columnar ferrite core 2 as shown in FIG. 1 is enclosed such that it is placed at the end surface 52 side in the axial direction of the outer shell body 50. Note that the outer shell body 50 is formed by molding according to injection molding technique so that the wireless IC tag (main body) 1 is enclosed inside the outer shell body 50. By forming the wireless IC tag as described above, the columnar wireless IC tag (main body) 1 is fixed in the central part of the outer shell body 50 being columnar as well, and almost no movement of the wireless IC tag (main body) 1 in the outer shell body 50 may be caused. Therefore, as far as the wireless IC tag 5 is fixed in place, in the right direction and at the right angle to the writing position of the reader/writer, data communication may be accomplished in the correct writing direction to the axial direction of the antenna.

As the material for molding the outer shell body 50, a synthetic resin material which is excellent in the strength and the stability to chemicals shall be selected, so that the wireless IC tag (main body) 1 can be protected during such a period that the wireless IC tag 5 is subjected to kneading with the material for building a construction and is remained in the embedded state in the hardened material used for building the construction. Particularly, when cement with strong alkalinity is used as the material for building the construction, either a polypropylene resin or a polyamide resin, which is resistant to alkali and has high strength, is used as the material for molding the outer shell body. Besides, these resins may be reinforced with a reinforcing material, such as glass fibers and inorganic filler. Further, a glassy material for adjusting specific gravity use may be added to a resin composing the outer shell body 50 and kneaded together so that the specific gravity of the wireless IC tag 5 is adjusted to the suitable range for the distribution in the material for building a construction. For example, a suitable range of the specific gravity of the wireless IC tag 5 to be kneaded with the material for building a construction is approximately from 1.3 to 2.3.

### EXAMPLE 3

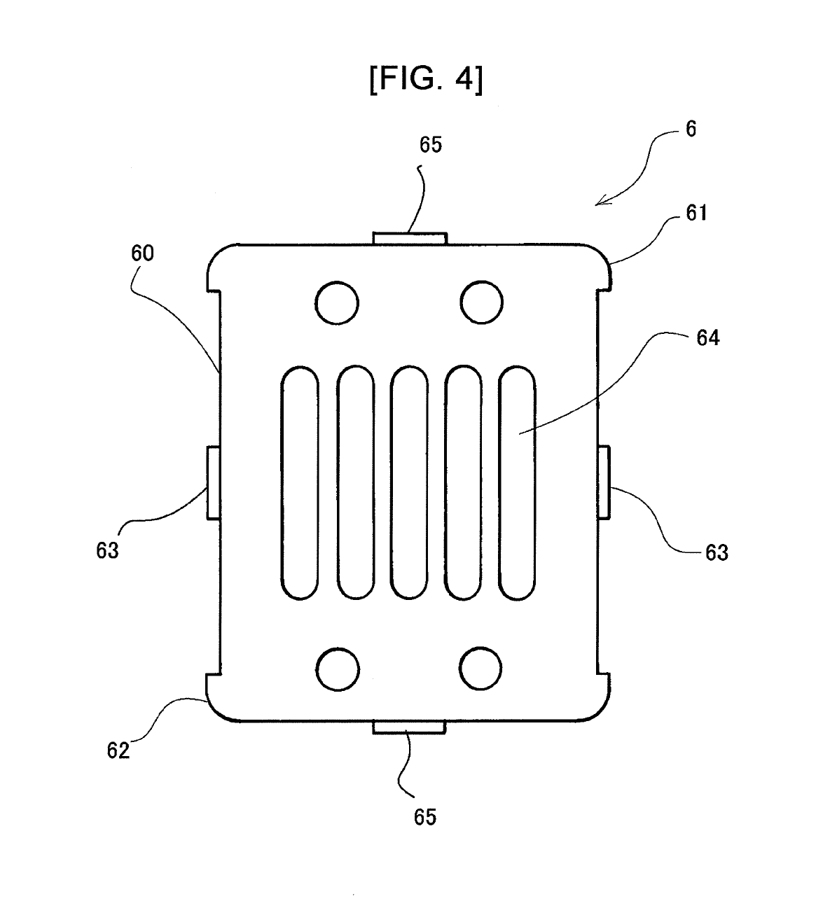

Besides, the wireless IC tag 6 shown in FIG. 4 is configured such that the circumferential protrusions 61, 62 provided to the peripheries of both end portions of the columnar outer shell body 60 enclosing the wireless IC tag (main body) 1 are formed in a flange shape. The protrusions 61, 62 are shaped in a bobbin form, that is, the ridges of the protrusions are respectively round chamfered and connected to the both end surfaces of the outer shell body, and a plurality of shallow concave grooves 64 may be provided to the body section of the outer shell body 60. By virtue of arranging the protrusions 61, 62, the wireless IC tag 6 can be thrown to a further far position without getting problems of being caught and remained at the release outlet 91 of the IC tag introducing machine 90 and of causing air leakage of compressed air from the gap between a hose and the wireless IC tag, when the wireless IC tags 6 are fed from the release outlet 91 of the IC tag introducing machine 90 described later through the hose to a kneading vessel, even though burr-like protrusions 63, 65 so configured as to correspond to the shape of the injection inlet for injection molding are formed at the time of molding using a die. As the other shapes of the outer shell body, various shapes including global, elliptic, bale-like, barrel-like, parallelpiped and the like may be exemplified.

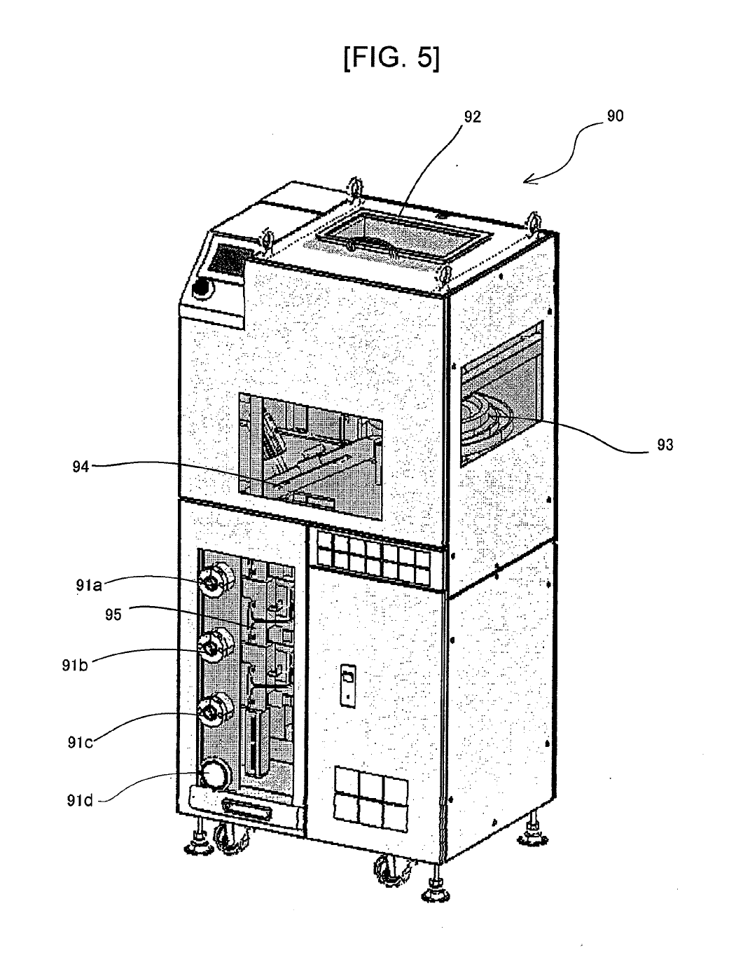

FIG. 5 is a perspective view showing the appearance from the front side of the IC tag introducing machine 90, which is useful to introduce the wireless IC tag 5 or the wireless IC tag 6 according to the present invention. This example shows a vertical-type IC tag introducing machine, in which a plurality of tag releasing outlets 91a to 91d are aligned in a vertical direction. This IC tag introducing machine 90 has an IC tag feed hopper 92 at the top, and hoses (not shown) are connected to the plural tag releasing outlets 91. The wireless IC tags are released in series from each of those tag releasing outlets 91 to a kneading vessel (not shown) for fresh concrete. The columnar wireless IC tags are fed at a predetermined interval from the tag feed hopper 92 locating at the top into a vibratory alignment device 93 adapted to uniform the aspect of each IC tag and are fallen through the inclined falling chute 94 while keeping the state of the IC tags such that the end surface thereof are directed to the falling direction. Then, data writing is carried out at the stop position of the vertical falling passage 95 at the lower side by the reader/writer (not shown). Then, the wireless IC tags are fed in series from the vertical falling passage 95 to the lateral releasing outlets 91 and are blown out by means of compressed air from the releasing outlets 91 via hoses to over the kneading vessel.

Besides, the wireless IC tags 5, 6 having had kneaded in a kneading vessel with fresh concrete are carried by a vehicle loading a concrete mixer thereon to a construction site and are fed together with fresh concrete by virtue of compressed air to be casted for building a concrete construction. After being casted, the wireless IC tag are remained inside the concrete construction and are adapted to implement radio communication with the reader/writer locating outside the concrete construction.

With the wireless IC tag according to the present invention, the communication distance and the directionality of the antennas have been improved. Further, by molding the wireless IC tag with the protective enclosure, the wireless IC tag can be positioned in the central portion of the protective enclosure. Moreover, when the wireless IC tag having been molded with the protective enclosure is embedded in the casted material for building a construction, such as cement, mortar and a resin material, such that the wireless IC tag locates at a position certain distance inside from the surface of the construction, the wireless IC tag can perform data communication without error even though it is fixed at any positions and angles at random in the construction, e.g. even in the case that the wireless IC tag is embedded in the construction in an inclined state.

1. A wireless IC tag, wherein an RFID tag module is mounted to a columnar ferrite core and antennas configured by being connected to said RFID tag module are wound around the surface of said columnar ferrite core.

2. A wireless IC tag according to claim 1, wherein the antennas to be wound around the ferrite core is consisted of a primary antenna to be wound around at the central part of the body section of the columnar ferrite core and a pair of secondary antennas to be wound around the positions locating both sides of said primary antenna.

3. A wireless IC tag according to claim 1, wherein the antennas to be arranged to the ferrite core are formed by printing technique.

4. A wireless IC tag according to claim 1 characterized in that the wireless IC tag comprising a columnar ferrite core on which an RFID tag module is mounted and antennas wound around the columnar ferrite core is formed by molding the wireless IC tag with a protective enclosure.

5. A wireless IC tag according to claim 4, wherein the protective enclosure is a columnar outer shell body.

6. A wireless IC tag according to claim 5, wherein circumferential protrusions are formed on the outer peripheries of both end portions of the columnar outer shell body.

7. A wireless IC tag according to claim 5, wherein a plurality of concave grooves extending in the axial direction are formed on the body section of the columnar outer shell body.

8. A wireless IC tag according to claim 2, wherein the antennas to be arranged to the ferrite core are formed by printing technique.

9. A wireless IC tag according to claim 2 characterized in that the wireless IC tag comprising a columnar ferrite core on which an RFID tag module is mounted and antennas wound around the columnar ferrite core is formed by molding the wireless IC tag with a protective enclosure.

10. A wireless IC tag according to claim 3 characterized in that the wireless IC tag comprising a columnar ferrite core on which an RFID tag module is mounted and antennas wound around the columnar ferrite core is formed by molding the wireless IC tag with a protective enclosure.

11. A wireless IC tag according to claim 8 characterized in that the wireless IC tag comprising a columnar ferrite core on which an RFID tag module is mounted and antennas wound around the columnar ferrite core is formed by molding the wireless IC tag with a protective enclosure.

12. A wireless IC tag according to claim 9, wherein the protective enclosure is a columnar outer shell body.

13. A wireless IC tag according to claim 10, wherein the protective enclosure is a columnar outer shell body.

14. A wireless IC tag according to claim 11, wherein the protective enclosure is a columnar outer shell body.

15. A wireless IC tag according to claim 12, wherein circumferential protrusions are formed on the outer peripheries of both end portions of the columnar outer shell body.

16. A wireless IC tag according to claim 13, wherein circumferential protrusions are formed on the outer peripheries of both end portions of the columnar outer shell body.

17. A wireless IC tag according to claim 14, wherein circumferential protrusions are formed on the outer peripheries of both end portions of the columnar outer shell body.

18. A wireless IC tag according to claim 6, wherein a plurality of concave grooves extending in the axial direction are formed on the body section of the columnar outer shell body.

19. A wireless IC tag according to claim 12, wherein a plurality of concave grooves extending in the axial direction are formed on the body section of the columnar outer shell body.

20. A wireless IC tag according to claim 13, wherein a plurality of concave grooves extending in the axial direction are formed on the body section of the columnar outer shell body.
